(19) United States
(12) Patent Application Publication
(10) Pub. No.: US 2006/0039052 A1
(43) Pub. Date: Feb. 23, 2006

(54) Method and mechanism for suppressing adverse influence on imaging of symptoms of optical elements

(75) Inventor: Kimihiko Sano, Yamanashi Prefecture (JP)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: Casio Micronics Co., Ltd.

(21) Appl. No.: 11/083,395

(22) Filed: Mar. 18, 2005

(30) Foreign Application Priority Data
Aug. 18, 2004 (JP) 2004-238451

(51) Int. Cl. G02B 26/08

(52) U.S. Cl. 359/196

(57) ABSTRACT

This invention relates to a method of forming an object image on an imaging surface using a lens such as a condenser lens, projection lens unit, or the like as an optical element. The object image is formed on the imaging surface while rotating a section perpendicular to the thickness direction of the lens in a direction perpendicular to the optical axis to have the center of that section as the center.

### CROSS-REFERENCE TO RELATED APPLICATIONS

This application is based upon and claims the benefit of priority from prior Japanese Patent Application No. 2004-238451, filed Aug. 18, 2004, the entire contents of which are incorporated herein by reference.

### BACKGROUND OF THE INVENTION

1. Field of the Invention

The present invention relates to a method and mechanism for suppressing the adverse influence on imaging of such symptoms as distortion and nonuniform transmittance in optical elements such as lenses, mirrors, and optical filters, and, more particularly, to an exposure apparatus, movie projector, and video camera which adopt this mechanism.

2. Description of the Related Art

For example, exposure apparatus, optical apparatuses such as a steppers, movie projectors, still cameras, video cameras, microscopes, spectroscopes, and telescopes use optical elements such as lenses, mirrors, and optical filters. FIG. 1 is a functional block diagram showing an example of a projection-type exposure apparatus using such optical elements.

That is, as shown in FIG. 1, in the projection type exposure apparatus, light coming from a light source such as a UV lamp 12, which is surrounded by a collection mirror 10 is reflected by a reflecting mirror 14, and is guided to an integrator lens 16. After the light is equalized by the integrator lens 16, it is guided to a condenser lens 20 by a reflecting mirror 18, and is collimated by the condenser lens 20. In this manner, a glass mask 24 whose outer peripheral portion is placed on a frame of a frame-shaped mask stage 22 is irradiated with this collimated light.

The light that strikes the glass mask 24 passes through the glass mask 24, and undergoes focus adjustment by a projection lens unit 26. As a result, an image of a pattern formed on the glass mask 24 is formed on an imaging surface 28.

Note that a shutter 17 is arranged between the integrator lens 16 and the reflecting mirror 18, and is closed when the glass mask 24 is not irradiated with light from the UV lamp 12.

The manufacturing technique of optical elements used in the optical apparatus such as the exposure apparatus have been strongly developed, and these elements are manufactured with higher precision. However, slight variations of performance inevitably occur due to individual differences. It is practically impossible to manufacture identical optical elements having uniform performance as a whole, and distortion and nonuniformity of transmittance are unavoidable.

Hence, in order to suppress the adverse influence on imaging of such symptoms in optical elements, in an optical apparatus using these optical elements, measures are taken, such as components being upgraded to improve their performance, and the characteristics of individual optical elements being measured in advance to correct an exposure mask, as described in, e.g., Jpn. Pat. Appln. KOKAI Publication Nos. 2004-70192 and 2002-199203.

However, these conventional methods pose the following problems.

That is, the aforementioned conventional methods can be taken only in the manufacturing process of an optical apparatus. Hence, no measures against distortion, change in transmittance, and symptoms due to attachment of dust, scratching, and the like can be taken after the manufacture of the optical apparatus.

### BRIEF SUMMARY OF THE INVENTION

The present invention has been made in consideration of the above situation, and has as its object to provide a method and mechanism which can suppress the adverse influence on imaging of symptoms exhibited by optical elements such as lenses, mirrors, and optical filters, not only in the manufacturing process of optical apparatuses such as exposure apparatuses, steppers, movie projectors, still cameras, video cameras, microscopes, spectroscopes, and telescopes, but also after their manufacture.

In order to achieve the above object, the present invention takes the following means.

That is, according to a first aspect of the present invention, there is provided a method of forming an object image on an imaging surface using an optical element, comprising: forming the object image on the imaging surface while rotating an optical effect surface of the optical element to have a surface center thereof as a center.

By taking such means, for example, even when distortion and a change in transmittance have occurred, dust is attached, scratches are formed, and so forth after the manufacture of a mirror and optical filter, the adverse influences of them on imaging are dispersed concentrically, and can be prevented from being intensively imposed on a given portion. Hence, the adverse influences of symptoms of these optical elements on imaging can be suppressed.

On the other hand, when a lens is used as the optical element, the object image is formed on the imaging surface while rotating a section perpendicular to a thickness direction of the lens in a direction perpendicular to an optical axis direction to have a center of the section as a center.

By taking such means, for example, even when distortion and a change in transmittance have occurred, dust is attached, scratches are formed, and so forth after the manufacture of a lens, the adverse influences of them on imaging are dispersed concentrically, and can be prevented from being intensively imposed on a given portion. Hence, the adverse influences of symptoms of these optical elements on imaging can be suppressed.

When an image is formed using a plurality of optical elements, at least one of the plurality of optical elements is rotated in a direction opposite to a rotation direction of another optical element. With this method, even when a plurality of optical elements are used, respective factors of the adverse influences of these plurality of optical elements on imaging can be dispersed concentrically. Such an effect can also be obtained by rotating at least one of the plurality of optical elements at a rotational speed different from a rotational speed of another optical element in the same rotation direction.

With these methods, the adverse influences imposed by a plurality of optical elements can be avoided from being superposed. Hence, the adverse influences of symptoms of these optical elements on imaging can be suppressed.

According to a second aspect of the present invention, there is provided a mechanism for forming an object image on an imaging surface using an optical element, comprising: rotation means for rotating an optical effect surface of the optical element to have a surface center thereof as a center. In order to efficiently and reliably rotate the optical element, the rotation means comprises fixing means for fixing the optical element, and driving means for rotating the optical element by rotating the fixing means.

By taking such means, for example, even when distortion and a change in transmittance have occurred, dust is attached, scratches are formed, and so forth after the manufacture of a mirror and optical filter, the adverse influences of them on imaging are dispersed concentrically, and can be prevented from being intensively imposed on a given portion. Hence, the adverse influences of symptoms of these optical elements on imaging can be suppressed.

On the other hand, when a lens is used as the optical element, the rotation means rotates a section perpendicular to a thickness direction of the lens in a direction perpendicular to an optical axis direction to have a center of the section as a center.

In this way, for example, even when distortion and a change in transmittance have occurred, dust is attached, scratches are formed, and so forth after the manufacture of a lens, the adverse influences of them on imaging are dispersed concentrically, and can be prevented from being intensively imposed on a given portion. Hence, the adverse influences of symptoms of these optical elements on imaging can be suppressed.

Also, when an image is formed using a plurality of optical elements, the rotation means is equipped for each of the plurality of optical elements, and the mechanism further comprises control means for controlling each rotation means to rotate at least one of the plurality of optical elements in a direction opposite to a rotation direction of another optical element. With this mechanism, even when a plurality of optical elements are used, respective factors of the adverse influences of these plurality of optical elements on imaging can be dispersed concentrically. Such an effect can also be obtained by further comprising control means for controlling each rotation means to rotate at least one of the plurality of optical elements at a rotational speed different from a rotational speed of another optical element in the same rotation direction, and rotating at least one of the plurality of optical elements at a rotational speed different from a rotational speed of another optical element in the same rotation direction under the control of this control means.

With these means, the adverse influences imposed by a plurality of optical elements can be avoided from being superposed. Hence, the adverse influences of symptoms of these optical elements on imaging can be suppressed.

According to a third aspect of the present invention, there are provided an exposure apparatus, movie projector, and video camera each of which comprises a mechanism of the second aspect and exposes an image formed on an imaging surface.

The exposure apparatus, movie projector, and video camera with this arrangement can suppress the adverse influences caused when distortion has occurred, transmittance has been locally changed, dust is attached, scratches are formed, and so forth after the manufacture of optical elements used.

As described above, according to the method and mechanism of the present invention, the adverse influence on imaging of symptoms exhibited by optical elements such as lenses, mirrors, and optical filters can be suppressed not only in the manufacturing process of optical apparatuses such as exposure apparatuses, steppers, movie projectors, still cameras, video cameras, microscopes, spectroscopes, and telescopes, but also after their manufacture.

By adopting such a method and mechanism, an optical apparatus which can suppress the adverse influence on imaging of symptoms exhibited by these optical elements, not only in the manufacturing process but also after manufacture, can be realized.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below serve to explain the principles of the invention.

FIG. 1 is a functional block diagram showing an example of a conventional projection type exposure apparatus;

FIG. 2 is a schematic view for explaining a method of rotating a condenser lens and projection lens unit;

FIG. 3 is a schematic view for explaining a method of rotating a condenser lens and projection lens unit;

FIG. 4 is a schematic view showing the relationship between an original image fixed on a mask stage, and an image of the original image formed on an imaging surface;

FIG. 5 shows an example of an original image fixed on the mask stage;

FIG. 6 shows an example of an image obtained by forming the original image shown in FIG. 5 on the imaging surface;

FIG. 7 shows an example of an image formed by concentrically dispersing the influences of symptoms;

FIG. 8 shows an example of an image which changes upon rotation of the condenser lens;

FIG. 9 shows an example of an image which changes upon rotation of the condenser lens;

FIG. 10 shows an example of an image which changes upon rotation of the condenser lens;

FIG. 11 shows an example of an image which changes upon rotation of the condenser lens;

FIG. 12 shows an example of an image which changes upon rotation of the condenser lens;

FIG. 13 is a side view showing an example of a condenser lens that adopts a rotation mechanism using bearings;

FIG. 14 is a top view of the condenser lens that adopts the rotation mechanism shown in FIG. 13;

FIG. 15 is a side view showing an example of a projection lens unit that adopts a rotation mechanism using bearings;

FIG. 16 is a side view showing an example of a condenser lens that adopts a rotation mechanism using hardballs;

FIG. 17 is a side view showing an example of a projection lens unit that adopts a rotation mechanism using hardballs;

FIG. 18 is a detailed view of principal part of a lens stage shown in FIGS. 16 and 17;

FIG. 19 is a top view of the projection lens unit that adopts the rotation mechanism shown in FIGS. 16 and 17;

FIG. 20 is a side view showing an example of a condenser lens that adopts a rotation mechanism using floating air;

FIG. 21 is a side view showing an example of a projection lens unit that adopts a rotation mechanism using floating air;

FIG. 22 is a detailed view of principal part of a lens stage shown in FIGS. 20 and 21;

FIG. 23 is a top view of the lens fixing ring shown in FIGS. 20 and 21;

FIG. 24 is a plan view of the lens stage shown in FIGS. 20 and 21;

FIG. 25 is a view showing an example of the arrangement of a movie projector that adopts the mechanism according to an embodiment of the present invention; and

FIG. 26 is a diagram showing an example of the arrangement of a video camera that adopts the mechanism according to an embodiment of the present invention.

### DETAILED DESCRIPTION OF THE INVENTION

The best mode of carrying out the present invention will be described hereinafter with reference to the accompanying drawings.

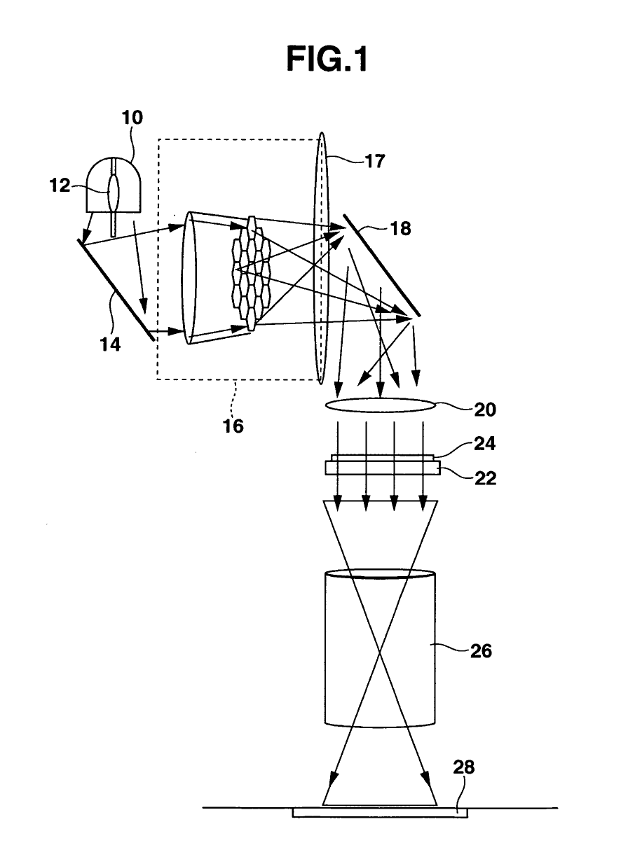

Note that the same reference numerals as in FIG. 1 are used in figures used to explain the following embodiments.

A method and mechanism according to an embodiment of the present invention are suitably applied to optical apparatuses such as exposure apparatuses, steppers, movie projectors, still cameras, video cameras, microscopes, spectroscopes, and telescopes, each of which uses optical elements such as lenses, mirrors, and optical filters. The method and mechanism do not remove symptoms (distortion, local transmittance difference, attachment of dust and scratches, and the like) that adversely influence on imaging, but minimize the adverse influence of these symptoms. The method and mechanism according to this embodiment will be explained using an example which is applied to an exposure apparatus whose arrangement is shown in FIG. 1.

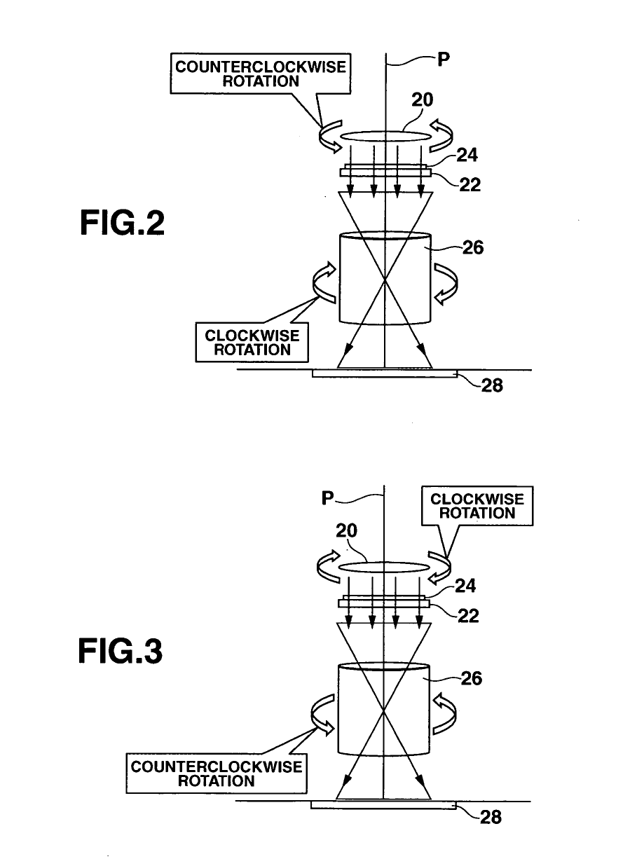

For example, when the adverse influences of symptoms of a condenser lens 20 and projection lens unit 26 in the exposure apparatus on imaging are to be suppressed, exposure is made by rotating the sections perpendicular to the thickness direction of the lenses of the condenser lens 20 and projection lens unit 26 perpendicularly to the optical axis direction P (which agrees with the thickness direction of the lens) to have their centers as the center, as shown in FIGS. 2 and 3.

Since symptoms always occur in predetermined directions, the influences of symptoms are concentrically dispersed to suppress the adverse influences in one direction and on one portion by rotating the condenser lens 20 and projection lens unit 26 during the exposure operation.

The rotational speed of the condenser lens 20 and projection lens unit 26 requires a value that allows to make at least 360° revolution (one revolution) during the exposure operation, and a better suppression effect can be obtained as it is faster.

As shown in FIGS. 2 and 3, the condenser lens 20 and projection lens unit 26 are preferably rotated in opposite directions. In FIG. 2, the condenser lens 20 is rotated counterclockwise, and the projection lens unit 26 is rotated clockwise. Conversely, in FIG. 3, the condenser lens 20 is rotated clockwise, and the projection lens unit 26 is rotated counterclockwise. With this mechanism, factors of the adverse influences of a plurality of optical elements on imaging can be concentrically dispersed, and the adverse influences of the plurality of optical elements can be avoided from being superposed.

Furthermore, in place of rotations in the opposite directions, the condenser lens 20 and projection lens unit 26 may be rotated in the same direction at different rotational speeds. With this mechanism as well, factors of the adverse influences of a plurality of optical elements on imaging can be concentrically dispersed, and the adverse influences of the plurality of optical elements can be avoided from being superposed.

Likewise, an integrator lens 16 and reflecting mirrors 14 and 18 may be rotated during the exposure operation. As for the reflecting mirrors 14 and 18, their optical effect surfaces, i.e., mirror surfaces are rotated to have the surface centers as the center. As for the integrator lens 16, a section perpendicular to the thickness direction of the lens is rotated to have its center as the center. Although not shown, if an optical filter is used, this optical filter is rotated to have the surface center of its surface as the center.

The optical path of light from the UV lamp 12 suffers factors such as a change in intensity of light, nonuniformity of reflectance, and the like. The influences of the illuminance difference and shadow produced during collection and mixing of light by the integrator lens 16 cannot be effectively removed even when the condenser lens 20 and projection lens unit 26 are rotated. In such case, by rotating the integrator lens 16 and the reflecting mirrors 14 and 18, the influences of a change in intensity of light, nonuniformity of reflectance, and the like due to symptoms of the integrator lens 14 and the reflecting mirrors 14 and 18 are concentrically dispersed, and the adverse influences in one direction and on one portion are suppressed.

The effects of the method and mechanism according to this embodiment with the above arrangement will be explained below.

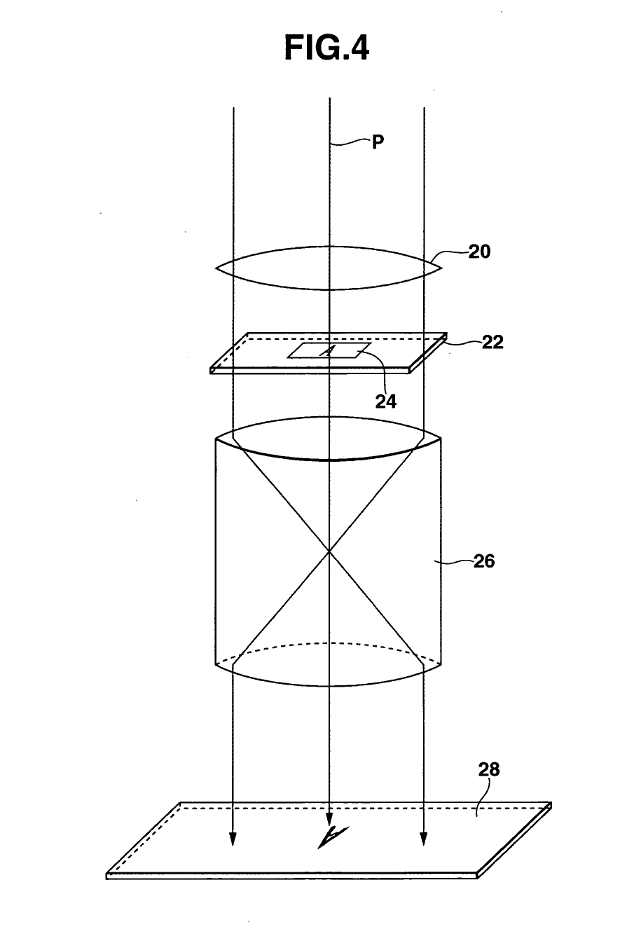

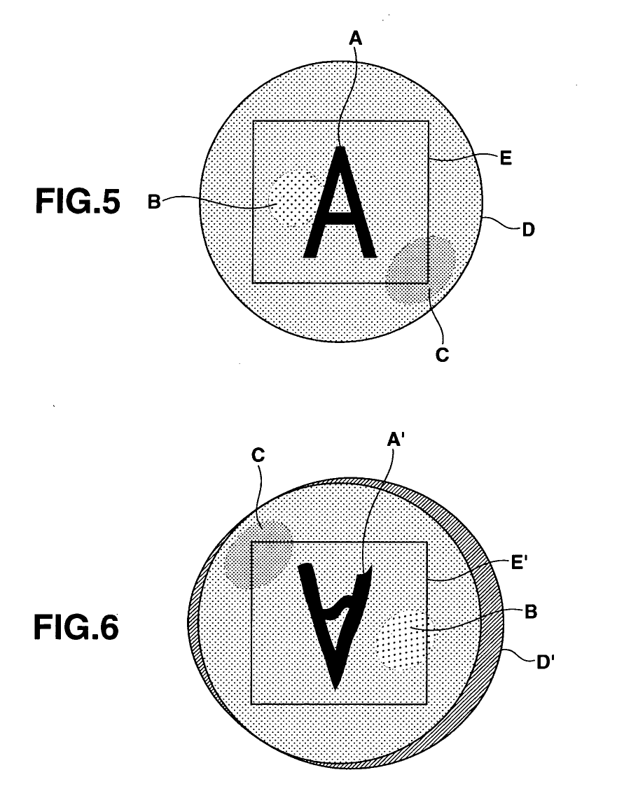

Assume that the condenser lens 20 and projection lens unit 26 suffer symptoms that adversely influence imaging. When an original image A including a letter “A”, as shown in FIG. 5, is exposed without rotating the condenser lens 20 and projection lens unit 26 while being fixed on a mask stage 22, as shown in FIG. 4, since symptoms appear at only a specific point, a distorted image A′ shown in, e.g., FIG. 6 is clearly formed on an imaging surface 28. Also, a boundary portion D of the original image A shown in FIG. 5 is obtained as a distorted image D′ shown in FIG. 6.

In this case, when symptoms of the integrator lens 16 and the reflecting mirrors 14 and 18 cause a change in light intensity and nonuniformity of reflectance, a bright portion B and dark portion C are already formed from the stage of irradiating the original image A with light, as shown in FIG. 5. These bright portion B and dark portion C clearly appear on corresponding portions on the image shown in FIG. 6.

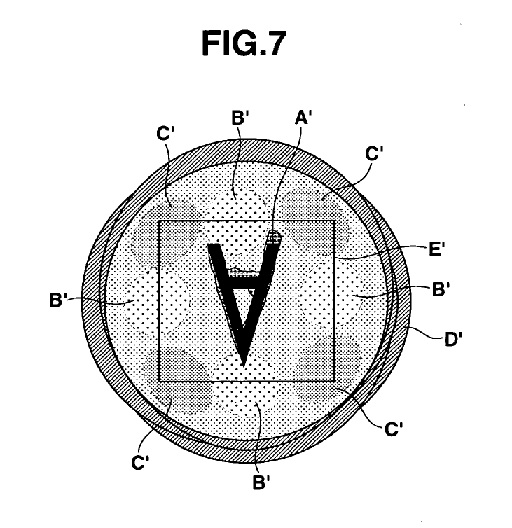

However, as shown in FIGS. 2 and 3, when exposure is made by making one revolution of the sections perpendicular to the thickness direction of the lenses of the condenser lens 20 and projection lens unit 26 perpendicularly to an optical axis direction P (which agrees with the thickness direction of the lens) to have their centers as the center, the influences of symptoms are concentrically dispersed. Hence, an image on which the adverse influences are wholly dispersed without being concentrated on one portion can be obtained, as shown in FIG. 7.

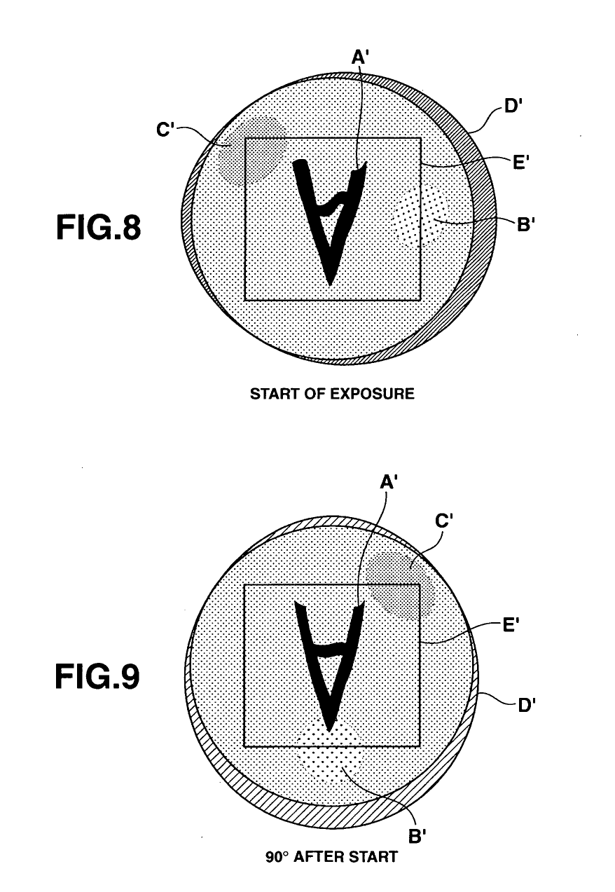

The principle of obtaining an image A′ shown in FIG. 7 will be described below using FIGS. 8 to 12. In FIGS. 8 to 12, assume that only the condenser lens 20 of the condenser lens 20 and projection lens unit 26 has symptoms that adversely influence an image, for the sake of simplicity.

FIG. 8 shows an image A′ formed on the imaging surface 28 while the condenser lens 20 is fixed, i.e., it is not rotated. In this case, a distorted image A′ is clearly formed on the imaging surface 28. Also, the a boundary portion D of the original image A is obtained as a distorted image D′ shown in FIG. 9.

In this case, symptoms of the integrator lens 16 and the reflecting mirrors 14 and 18 cause a change in light intensity and nonuniformity of reflectance. When a bright portion B and dark portion C are already formed from the stage of irradiating the original image A with light, as shown in FIG. 5, these bright portion B and dark portion C clearly appear on corresponding portions of the image shown in FIG. 8.

FIG. 9 shows an image A′ clearly formed on the imaging surface 28 after the condenser lens 20 has been rotated clockwise 90° (¼ revolution). In this case, as can be seen from FIG. 9, a distorted image A′ is formed on the imaging surface 28, but the degree of distortion becomes smaller than the image A′ shown in FIG. 8. That is, the condenser lens 20 has better symmetry when it is rotated than when not rotated. Since the condenser lens 20 has been rotated clockwise 90° (¼ revolution), a bright portion B′ and dark portion C appear at portions which have been rotated clockwise 90°. Also, distortion of a boundary portion D′ has been moved clockwise ¼ revolution.

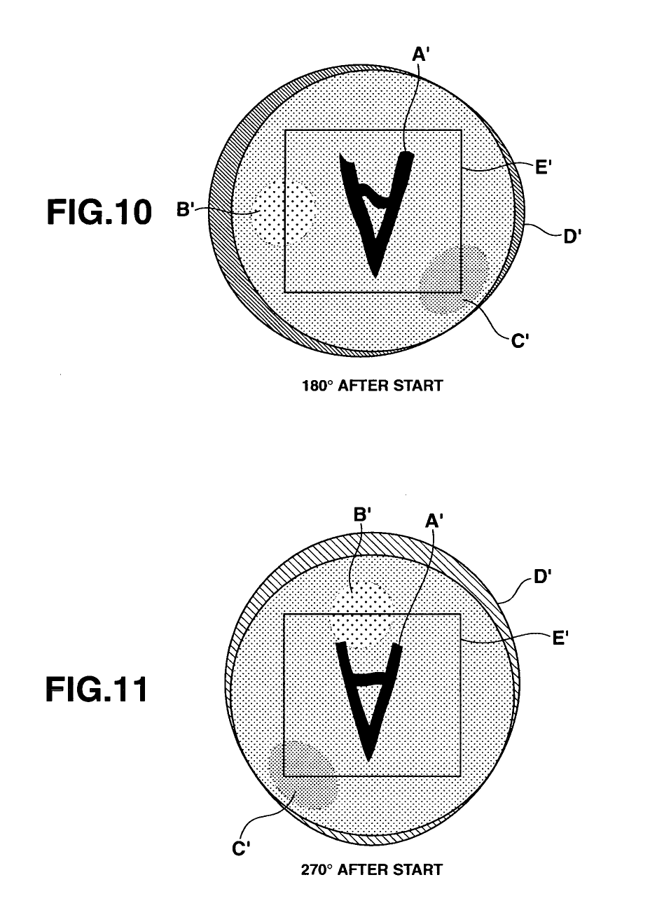

FIG. 10 shows an image A′ clearly formed on the imaging surface 28 after the condenser lens 20 has been rotated clockwise another 90° (¼ revolution), i.e., after it has been rotated 180° from the state shown in FIG. 8. The image A′ obtained in this case is symmetrical to the non-rotated image A′ shown in FIG. 8. Since the condenser lens 20 has been rotated clockwise another 90° (¼ revolution) from the state shown in FIG. 9, a bright portion B′ and dark portion C′ appear at portions which have been rotated clockwise 90°. Also, distortion of a boundary portion D′ has been moved clockwise ¼ revolution.

FIG. 11 shows an image A′ clearly formed on the imaging surface 28 after the condenser lens 20 has been rotated clockwise another 90° (¼ revolution), i.e., after it has been rotated 270° from the state shown in FIG. 8. The image A′ obtained in this case is symmetrical to the image A′ shown in FIG. 9. Since the condenser lens 20 has been rotated clockwise another 90° (¼ revolution) from the state shown in FIG. 10, a bright portion B′ and dark portion C′ appear at portions which have been rotated clockwise 90°. Also, distortion of a boundary portion D′ has been moved clockwise ¼ revolution.

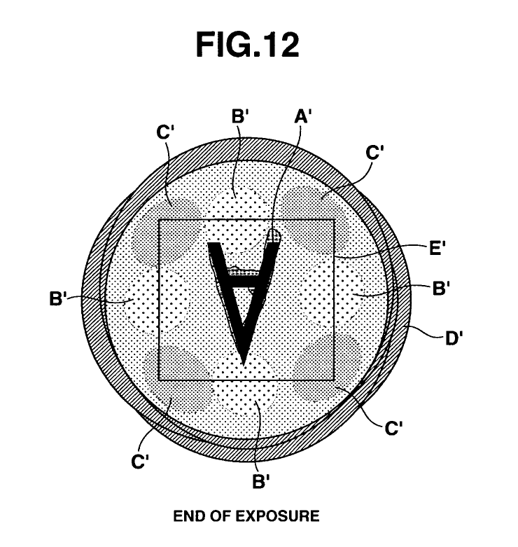

Therefore, when the condenser lens 20 makes one revolution during the exposure operation, an image formed by superimposing those shown in FIGS. 8, 9, 10, and 11 is obtained. FIG. 12 shows such image. Since the image A′ has slightly different shapes in FIGS. 8, 9, 10, and 11, the image A′ shown in FIG. 12 formed by superimposing these images has a dark, clear common portion but has a light, hazy non-common portion. For this reason, although the image A′ shown in FIG. 12 is formed not clearly so much as those shown in FIGS. 8, 9, 10, and 11, the influences of overall symptoms are concentrically dispersed. Hence, the adverse influences are suppressed, and an image closer to the original image A shown in FIG. 5 than the non-rotated image A′ shown in FIG. 8 can be obtained.

An example of a practical rotation mechanism that allows the aforementioned rotations of the optical elements will be explained below.

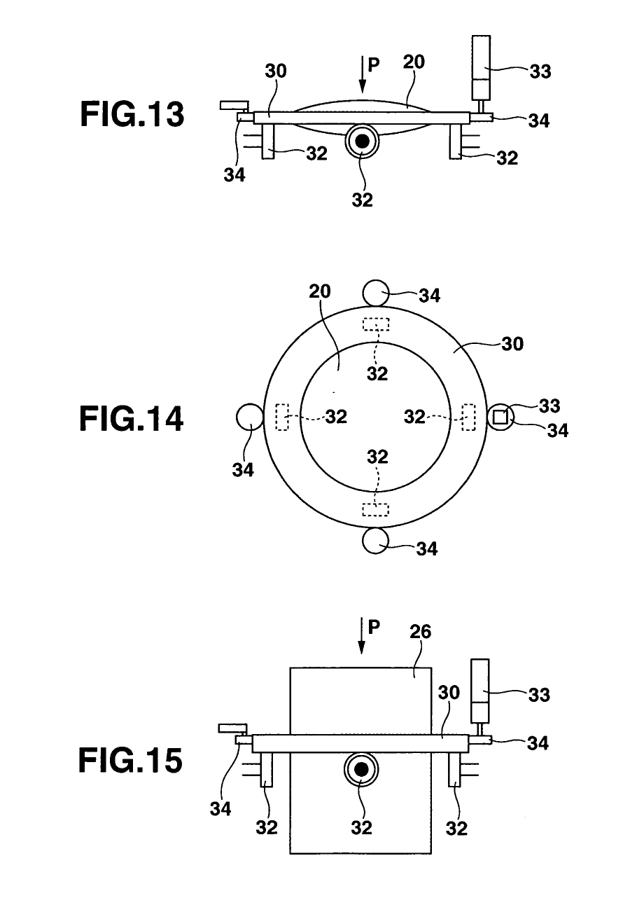

FIG. 13 is a side view showing an example of the condenser lens 20 that adopts such rotation mechanism, and FIG. 14 is a top view of this rotation mechanism. Assume that light enters this condenser lens 20 in the vertical optical axis direction P (top-down direction in FIG. 13). In this case, the perimeter of the maximum outer diameter of the condenser lens 20 is fixed by an annular lens fixing ring 30. Next, the lens fixing ring 30 is placed on four bearings 32, which are built in with high horizontal precision. The four bearings 32 are laid out at equal angular intervals that form 90° angular intervals with respect to the surface center of the condenser lens 20, as shown in FIG. 14. Furthermore, rubber guide rollers 34 are in contact with the outer side surface of the lens fixing ring 30. The four guide rollers 34 are also laid out at equal angular intervals that form 90° angular intervals with respect to the surface center of the condenser lens 20, as shown in FIG. 14. A driving motor 33 is connected to one of the four guide rollers 34. In place of the rubber guide rollers 34, metal gears may be used. However, the rubber guide rollers 34 are preferably used in terms of prevention of initial dust produced due to worn metal.

By driving the motor 33, the guide roller 34 connected to the motor 33 is rotated, and rotates the lens fixing ring 30 horizontally together with the condenser lens 20. The three remaining guide rollers 34 which are not connected to the motor 33 are rotated upon rotation of the lens fixing ring 30, thus supporting the lens fixing ring 30 and preventing a horizontal vibration. The rotational speed is adjusted by adjusting the driving velocity of the motor 33. The four bearings 32 horizontally hold the lens fixing ring 30 while preventing a vertical vibration during the rotation of the lens fixing ring 30 without disturbing the rotation of the lens fixing ring 30.

The rotation mechanism including the lens fixing ring 30, bearings 32, motor 33, and guide rollers 34 can be applied not only to the condenser lens 20 but also to the rotation of the projection lens unit 26, as shown in FIG. 15. Also, the rotation mechanism can be applied not only to the lens but also to the rotations of the mirrors and optical filters.

When the condenser lens 20 and projection lens unit 26 are rotated in the opposite directions, the rotational direction of the motor 33 used to drive the condenser lens 20 and that of the motor 33 used to drive the projection lens unit 26 are set in opposite directions. For example, when the condenser lens 20 and projection lens unit 26 are rotated at different rotational speeds, the rotational speed of the motor 33 used to drive the condenser lens 20 and that of the motor 33 used to drive the projection lens unit 26 are set to be different values.

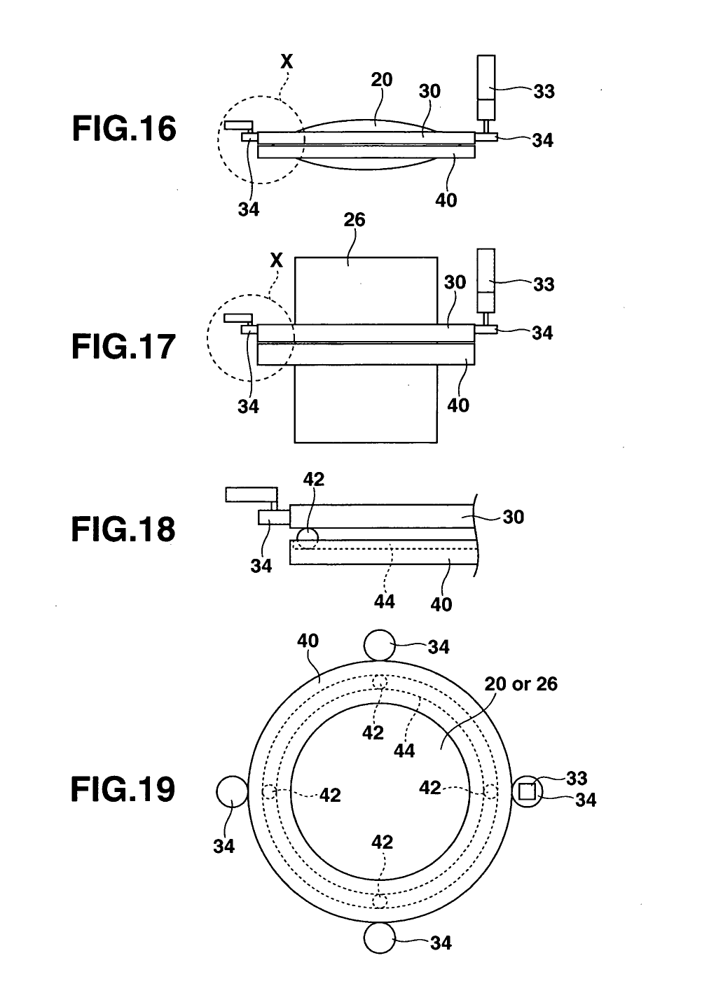

FIG. 16 is a side view showing an example of the condenser lens 20 that adopts another rotation mechanism, and FIG. 17 is a side view showing an example of the projection lens unit 26 that adopts another rotation mechanism. FIG. 18 is an enlarged view of a portion X in FIGS. 16 and 17, and FIG. 19 is a top view of FIG. 16 or 17.

That is, the rotation mechanism may use an annular lens stage 40 shown in FIG. 19 in place of the bearings 32 shown in FIGS. 13 and 15. The lens stage 40 has annular rail groove 44 that can hold hardballs 42, as shown in FIGS. 18 and 19. The rail groove 44 holds the hardballs 42 to be free to move and rotate along the groove. In FIG. 19, only four hardballs 42 are illustrated. However, the number of hardballs 42 is not limited to four, but four or more hardballs 42 may be used.

The hardballs 42 substitute for the bearings 32 shown in FIGS. 13 and 15. The lens fixing ring 30 is placed on these hardballs. During rotation of the lens fixing ring 30, the hardballs 42 themselves rotate and horizontally hold the lens fixing ring 30 while preventing a vertical vibration during the rotation of the lens fixing ring 30 without disturbing the rotation of the lens fixing ring 30.

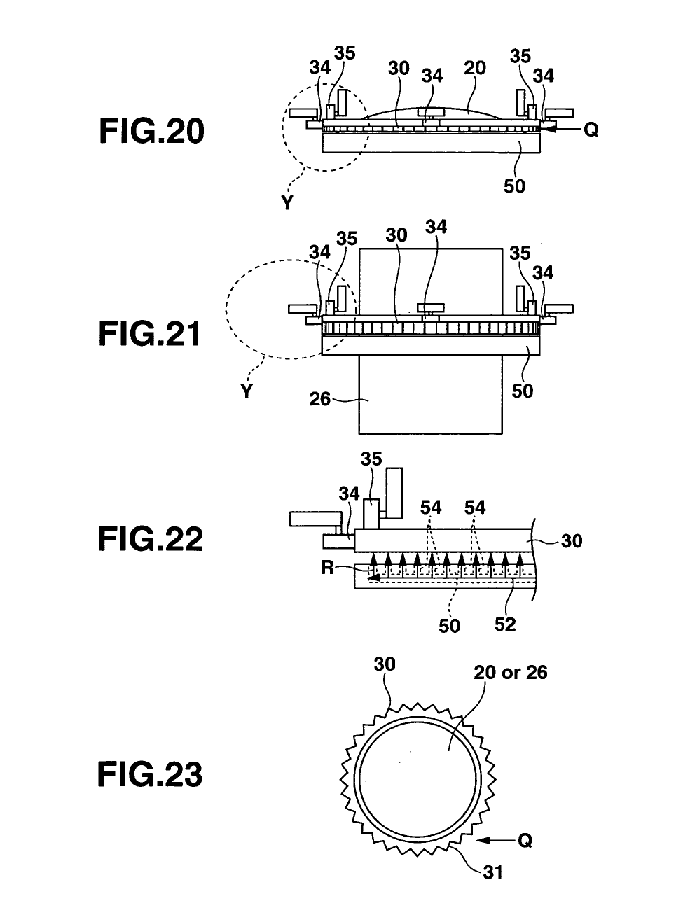

FIG. 20 is a side view showing an example of the condenser lens 20 that adopts still another rotation mechanism, and FIG. 21 is a side view showing an example of the projection lens unit 26 that adopts still another rotation mechanism. FIG. 22 is an enlarged view of a portion Y in FIGS. 20 and 21, and FIG. 23 is a top view of the lens fixing ring used in FIG. 20 or 21.

That is, the rotation mechanism may use an annular lens stage 50 which supplies floating air R used to float the lens fixing ring 30 to the lens fixing ring 30 in place of the lens stage 40 that holds the hardballs 42 shown in FIGS. 18 and 19.

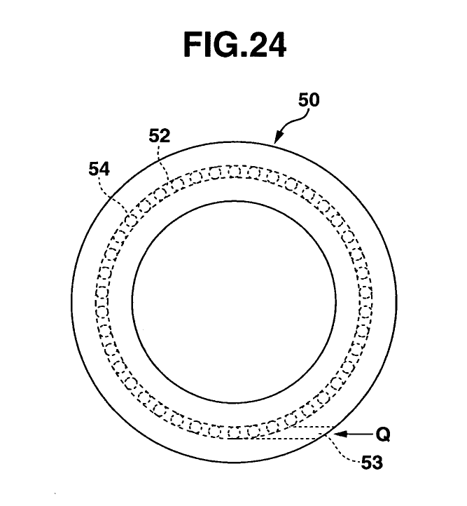

As shown in FIGS. 22 and 24, this lens stage 50 has an annular floating air circulating channel 52 in it. This floating air circulating channel 52 is connected to a floating air introduction port 53 from which compressed air is introduced as floating air R by a fan or the like (not shown). As shown in FIGS. 22 and 24, a large number of floating air exhaust holes 54 punched in the top surface direction of the lens stage 50 are formed at substantially equal pitches on the floating air circulating channel 52. In order to improve the floating effect, a larger number of floating air exhaust holes 54 with a smaller diameter are preferably formed.

With this arrangement, when floating air R is introduced from the floating air introduction port 53, this floating air R is exhausted from the floating air exhaust holes 54 via the floating air circulating channel 52 to float the lens fixing ring 30 placed on the lens stage 50.

In order to maintain the horizontal level of the floating lens fixing ring 30, four rubber guide rollers 35 are arranged at equal angular intervals (i.e., at 90° angular intervals to have the center of the lens held by the lens fixing ring 39 as the center) with high horizontal precision. Therefore, by supplying floating air R of a sufficient amount from the lens stage 50 to the lens fixing ring 30, the lens fixing ring 30 floats and is controlled by the four guide rollers 35, thus maintaining it horizontal.

The lens fixing ring 30 has a gear shape, as shown in FIG. 23, and a tooth portion serves as an air receiving surface 31 that receives rotation air Q. Therefore, rotation air Q is blown using a fan or the like (not shown) from the tangential direction toward the air receiving surface 31 of the lens fixing ring 30, as shown in FIG. 23, in a state wherein the lens fixing ring 30 floats in a horizontal state. Since the lens fixing ring 30 is held by guide rollers 34 as in the arrangement shown in FIGS. 13 to 19, it is rotated in a horizontal state without moving in the horizontal direction or vibrating in the vertical direction. In order to reduce wear upon rotation, the top surface of the lens stage 50 and the bottom surface of the lens fixing ring 30 are preferably mirror-finished.

The examples of the practical mechanisms that allow rotation of optical elements have been explained using FIGS. 13 to 24. Of course, the mechanism that allows rotation of optical elements is not limited to these specific mechanisms. For example, permanent magnets may be built into the lens fixing ring 30 and lens stage 40, and the lens fixing ring 30 which floats by magnetic repulsion may be rotated by energizing external coils owing to the principle of motor.

In the above description, the method and mechanism according to this embodiment have been explained using an example applied to the exposure apparatus. However, the method and mechanism according to this embodiment are not limited to the exposure apparatus, and can be similarly applied to any other optical apparatuses using optical elements such as a stepper, movie projector, still camera, video camera, microscope, spectroscope, telescope, and the like, thus assuring the same operations and effects. As typical examples, application examples of the method and mechanism according to this embodiment to a movie projector and video camera will be explained below.

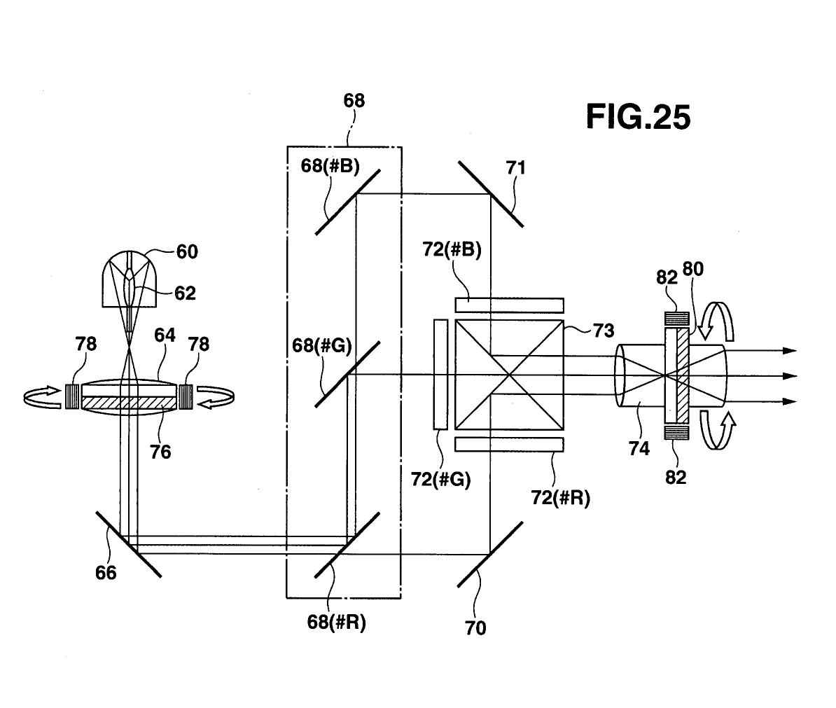

FIG. 25 shows an example of the arrangement of a movie projector that adopts the rotation mechanism according to this embodiment.

That is, as shown in FIG. 25, the movie projector is used as a projector or the like, and light from a lamp 62 surrounded by a collection mirror 60 is guided to a lens 64. The light is collimated by the lens 64, and is then guided to an RGB filter 68 by a reflecting mirror 66.

The RGB filter 68 includes an R filter 68(#R), G filter 68(#G), and B filter 68(#B). Of the light guided from the reflecting mirror 66, only a red light component is separated by the R filter 68(#R), and is guided to a reflecting mirror 70. The red light component is reflected by the reflecting mirror 70 and is guided to a prism 73 via a red liquid crystal 72(#R). The light other than the red component is guided from the R filter 68(#R) to the G filter 68(#G), and is separated into G and B light components. The G light component is guided to the prism 73 via a green liquid crystal 72(#G), and the B light component is guided to the B filter 68(#B). The B light component is guided to a reflecting mirror 71 by the B filter 68(#B), and is reflected by that mirror. The B light component is then guided to the prism 73 via a blue liquid crystal 72(#B). R, G, and B light components guided to the prism 73 in this way are output via a projection lens unit 74.

In the movie projector with such arrangement, lens fixing rings 76 and 80 with permanent magnets are respectively fixed to the lens 64 and projection lens unit 74, and coils 78 and 82 are respectively arranged around the lens fixing rings 76 and 80, as shown in FIG. 25. With this mechanism, by projecting an image while rotating the lens 64 and projection lens unit 74, the adverse influences due to symptoms of the lens 64 and projection lens unit 74 can be suppressed during projection. In this case, the lens 64 and projection lens unit 74 are rotated in opposite directions, or in the same direction at different rotational speeds.

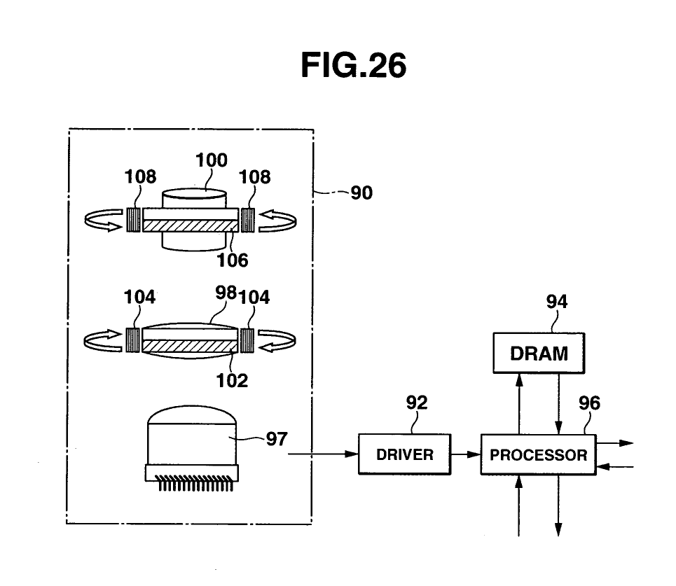

FIG. 26 is a schematic diagram showing an example in which the mechanism according to this embodiment is applied to a video camera. That is, the video camera generally comprises a light receiving unit 90, driver 92, DRAM 94, and processor 96. The receiving unit 90 uses a lens 98 and lens unit 100 in addition to a CCD 97.

Lens fixing rings 102 and 106 are respectively fixed to these lens 98 and lens unit 100, and coils 104 and 108 are arranged around the lens fixing rings 102 and 106, as shown in FIG. 26. With this mechanism, by receiving light while rotating the lens 98 and lens unit 100, the adverse influences due to symptoms of the lens 98 and lens unit 100 can be suppressed during reception. In this case, the lens 98 and lens unit 100 are rotated in opposite directions, or in the same direction at different rotational speeds.

As described above, since the rotation mechanism including the permanent magnet and coils in the movie projector and video camera has a compact size and can operate stably, it can rotate a lens without increasing the size of the movie projector and video camera. In case of an instantaneous operation of a camera or the like, a rotation mechanism with a mechanical structure using a power spring or spring may be used in place of the rotation mechanism including the permanent magnet and coils.

As described above, according to the method and mechanism of this embodiment, optical elements are rotated when they are used. Hence, even when symptoms due to distortion, a change in transmittance, attachment of dust, formation of scratches, and so forth after the manufacture of optical elements have occurred, the adverse influences of these symptoms on imaging can be concentrically dispersed, and the adverse influences caused by these symptoms can be suppressed.

In particular, when a plurality of optical elements are used, symptoms due to respective optical elements can be prevented from being superposed by rotating the optical elements in opposite directions or at different rotational speeds, thus suppressing the adverse influences as much as possible.

Furthermore, the method and mechanism according to this embodiment can be applied to arbitrary optical apparatuses such as an exposure apparatus, stepper, movie projector, still camera, video camera, microscope, spectroscope, telescope, and the like, each of which uses optical elements such as a lens, mirror, optical filter, and the like.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of forming an object image on an imaging surface using an optical element, comprising:
forming the object image on the imaging surface while rotating an optical effect surface of the optical element to have a surface center thereof as a center.

2. A method according to claim 1, wherein the optical element is at least one of a mirror and an optical filter.

3. A method of forming an object image on an imaging surface using a lens as an optical element, comprising:
forming the object image on the imaging surface while rotating a section perpendicular to a thickness direction of the lens in a direction perpendicular to an optical axis direction to have a center of the section as a center.

4. A method according to any one of claims 1 to 3, wherein when the object image is formed using a plurality of optical elements, at least one of the plurality of optical elements being rotated in a direction opposite to a rotation direction of another optical element.

5. A method according to any one of claims 1 to 3, wherein when the object image is formed using a plurality of optical elements, at least one of the plurality of optical elements being rotated at a rotational speed different from a rotational speed of another optical element in the same rotation direction.

6. A mechanism for forming an object image on an imaging surface using an optical element, comprising:
rotation means for rotating an optical effect surface of the optical element to have a surface center thereof as a center.

7. A mechanism according to claim 6, wherein the optical element is at least one of a mirror and an optical filter.

8. A mechanism for forming an object image on an imaging surface using a lens as an optical element, comprising:
rotation means for rotating a section perpendicular to a thickness direction of the lens in a direction perpendicular to an optical axis direction to have a center of the section as a center.

9. A mechanism according to any one of claims 6 to 8, wherein when the object image is formed using a plurality of optical elements, the rotation means is equipped for each of the plurality of optical elements, and the mechanism further comprises control means for controlling each rotation means to rotate at least one of the plurality of optical elements in a direction opposite to a rotation direction of another optical element.

10. A mechanism according to claim 9, wherein the rotation means comprises:
fixing means for fixing the optical element; and
driving means for rotating the optical element by rotating the fixing means.

11. A mechanism according to any one of claims 6 to 8, wherein when the object image is formed using a plurality of optical elements, the rotation means is equipped for each of the plurality of optical elements, and the mechanism further comprises control means for controlling each rotation means to rotate at least one of the plurality of optical elements at a rotational speed different from a rotational speed of another optical element in the same rotation direction.

12. A mechanism according to claim 11, wherein the rotation means comprises:
fixing means for fixing the optical element; and
driving means for rotating the optical element by rotating the fixing means.

13. A mechanism according to any one of claims 6 to 8, wherein the rotation means comprises:
fixing means for fixing the optical element; and
driving means for rotating the optical element by rotating the fixing means.

14. An exposure apparatus which comprises a mechanism of any one of claims 6 to 8 and exposes an image formed on the imaging surface.

15. An exposure apparatus which comprises a mechanism of claim 9 and exposes an image formed on the imaging surface.

16. An exposure apparatus which comprises a mechanism of claim 10 and exposes an image formed on the imaging surface.

17. An exposure apparatus which comprises a mechanism of claim 11 and exposes an image formed on the imaging surface.

18. An exposure apparatus which comprises a mechanism of claim 12 and exposes an image formed on the imaging surface.

19. An exposure apparatus which comprises a mechanism of claim 13 and exposes an image formed on the imaging surface.

20. A movie projector which comprises a mechanism of any one of claims 6 to 8 and projects an image formed on the imaging surface.

21. A movie projector which comprises a mechanism of claim 9 and projects an image formed on the imaging surface.

22. A movie projector which comprises a mechanism of claim 10 and projects an image formed on the imaging surface.

23. A movie projector which comprises a mechanism of claim 11 and projects an image formed on the imaging surface.

24. A movie projector which comprises a mechanism of claim 12 and projects an image formed on the imaging surface.

25. A movie projector which comprises a mechanism of claim 13 and projects an image formed on the imaging surface.

26. A video camera comprising:
a mechanism of any one of claims 6 to 8; and
a light receiving unit having the imaging surface.

27. A video camera comprising:
a mechanism of claim 9; and
a light receiving unit having the imaging surface.

28. A video camera comprising:
a mechanism of claim 10; and
a light receiving unit having the imaging surface.

29. A video camera comprising:
a mechanism of claim 11; and
a light receiving unit having the imaging surface.

30. A video camera comprising:
a mechanism of claim 12; and
a light receiving unit having the imaging surface.

31. A video camera comprising:
a mechanism of claim 13; and
a light receiving unit having the imaging surface.
